(19) United States
(12) Patent Application Publication
(10) Pub. No.: US 2009/0245646 A1
(43) Pub. Date: Oct. 1, 2009

(54) Online Handwriting Expression Recognition

(75) Inventors: Yu Shi, Beijing (CN); Frank Kao-Ping Soong, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/058,506

(22) Filed: Mar. 28, 2008

(51) Int. Cl. G06K 9/78

(52) U.S. Cl. 382/189

(57) ABSTRACT

One way of recognizing online handwritten mathematical expressions is to use a one-pass dynamic programming based symbol decoding generation algorithm. This method embeds segmentation into symbol identification to form a unified framework for symbol recognition. Along with decoding, a symbol graph is produced. Besides accurately recognizing handwritten mathematical expressions, this method can produce high quality symbol graphs. This method uses six knowledge source models to help search for possible symbol hypotheses during the decoding process. Here, knowledge source exponential weights and a symbol insertion penalty are used to weigh the various knowledge source model probabilities to increase accuracy.

### BACKGROUND

Personal Computer (PC) Tablets, Personal Digital Assistants (PDAs) and other computing devices that use a stylus or similar input device are increasing in use for inputting data. Inputting data using a stylus or similar device is advantageous because inputting data via handwriting is easy and natural. Input includes handwriting recognition of conventional text such as the handwritten expressions of spoken languages (for example, English words). Also included are handwritten mathematical expressions.

These handwritten mathematical expressions, however, present significant recognition problems to computing devices as mathematical expressions have not been recognized with high accuracy by existing handwriting recognition software packages. In general, handwritten mathematical expressions are more difficult for a computing device to recognize because the information contained in a handwritten mathematical expression may be, for example, dependent not only on the symbols within the expression, but on the symbol's positioning relative to each other.

Thus, a need exists for online handwritten mathematical expression recognition to enable pen-based input with greater accuracy and speed.

### SUMMARY

This document describes improving handwritten expression recognition by using symbol graph based discriminative training and rescoring. First, a one-pass dynamic programming based symbol decoding generation algorithm is used to embed segmentation into symbol identification to form a unified framework for symbol recognition. Through this decoding, a symbol graph is also produced. Second, the symbol graph can be optionally rescored for improved recognition.

In one embodiment, after decoding and rescoring, the rescored symbol graph is searched for a group of symbol graph paths. A best symbol graph path then is identified, which enables the computing device to present recognized handwriting to the user.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to accompanying figures. The use of the same reference numbers in different figures indicates similar or identical items.

FIG. 1 depicts an illustrative architecture in which a user inputs handwritten expressions into a computing device and the computing device recognizes the expression with the use of symbol graph based discriminative training.

FIG. 2 depicts a portion of an illustrative method, which may be executed by the computing device of FIG. 1, for recognizing a user's handwritten expressions.

FIG. 3 depicts the decoding portion of the illustrative method in FIG. 2.

FIG. 4 depicts an example of a symbol graph transformation in preparation for rescoring.

FIG. 5 depicts a portion of an illustrative user interface (UI) that allows a user to input a handwritten expression into a computing device and to confirm that the computing device recognized the expression.

FIG. 6 depicts the results of convergence of discriminative training using two different discriminative training criterion.

FIG. 7 depicts results of symbol accuracy in regards to discriminative training.

FIG. 8 depicts symbol accuracy and relative improvement obtained with different system configurations.

FIG. 9 depicts an embodiment's average symbol accuracy.

### DETAILED DESCRIPTION

### Overview

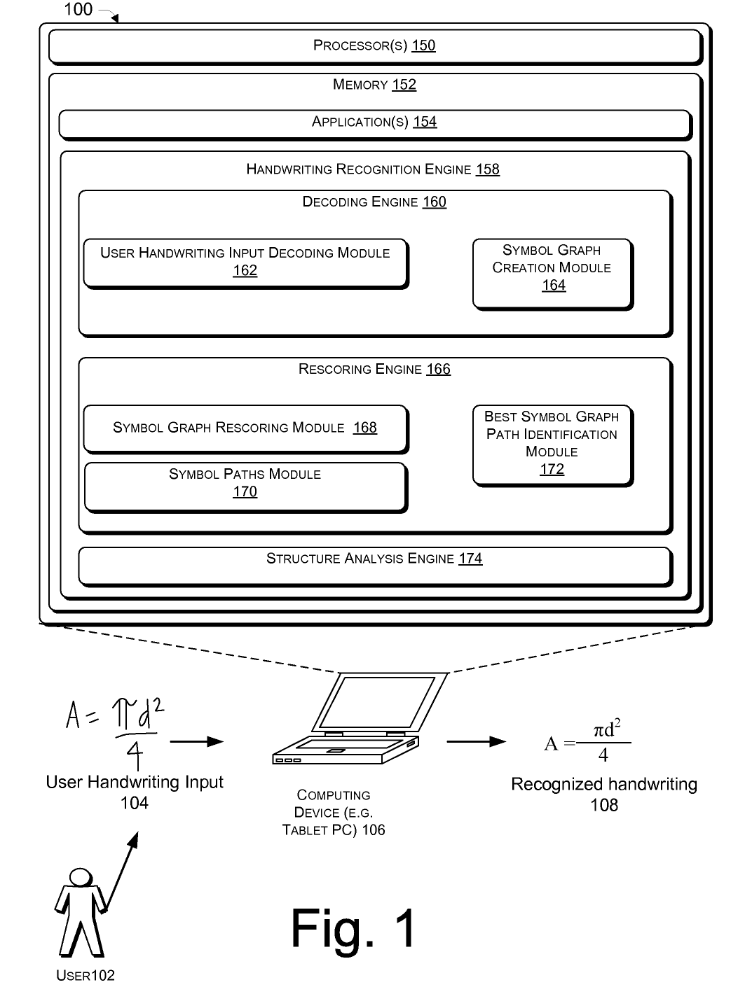

This document describes improving online handwritten expression recognition which includes online handwritten math symbol recognition by using symbol graph based discriminative training and rescoring. FIG. 1 depicts an illustrative architecture 100 that includes a computing device configured to recognize handwritten expressions. As illustrated, FIG. 1 includes a user 102, who may input a user handwriting input (e.g., a user stroke sequence) 104 into a computing device 106. An example of a computing device is a Tablet PC or a Personal Digital Assistant (PDA). Other computing devices can be used such as laptop computers, mobile phones, set top boxes, game consoles, portable media players, digital audio players and the like. As described in detail below, computing device 106 employs the described techniques to efficiently and accurately recognize user handwriting input 104.

Illustrative architecture 100 further includes one or more processors 150 as well as memory 152 upon which applications 154 and a handwriting recognition engine 158 may be stored. Applications 154 can be any application that can receive user handwriting input 104, either from the user before handwriting recognition engine 158 receives it, after handwriting recognition outputs recognized handwriting 108, or both. Applications 154 can be applications stored on computing device 106 or stored remotely.

Also illustrated in FIG. 1, the handwriting recognition engine 158 stored on or accessibly by computing device 106 functions to quickly and accurately recognize the user's handwriting input 104. Computing device 106 may then present recognized handwriting 108 to user 102 or may use recognized handwriting 108 for other purposes. As illustrated in the embodiment, handwriting recognition engine 158 contains a decoding engine 160, a rescoring engine 166, and a structure analysis engine 174.

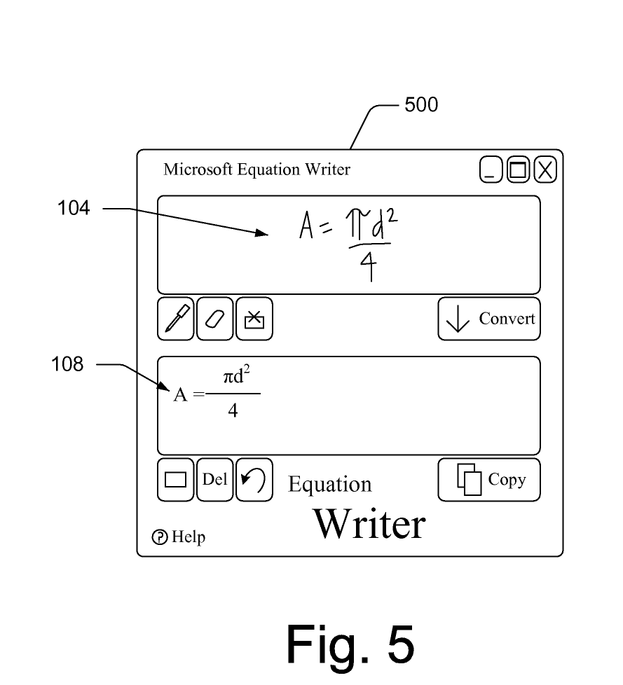

User handwriting input 104 can be input into computing device 106 via a Tablet PC using a stylus, a PDA using a stylus or the like. User handwriting input 104 can be directed to the handwriting recognition engine 158 through other applications 154 or the like or can be stored and later sent to the handwriting recognition engine 158. For example, user handwriting input 104 can be directed to applications 154 such as MICROSOFT WORD®, MICROSOFT ONENOTE® or the like and then directed to handwriting engine 158. In yet another embodiment, handwriting recognition engine 158 is included within MICROSOFT WORD® or another word processing application or the like. In yet another embodiment, handwriting recognition engine 158 is a separate application and receives user handwriting input 104 before sending it to the word processing or other application. These embodiments can be accomplished though an exemplary user interface 500 as illustrated in FIG. 5. In FIG. 5, user handwriting input 104 is input by user 102 into the exemplary user interface 500 which displayed by computing device 106. Thus computing device 106 displays the most likely expression that the user 102 actually entered as recognized handwriting 108.

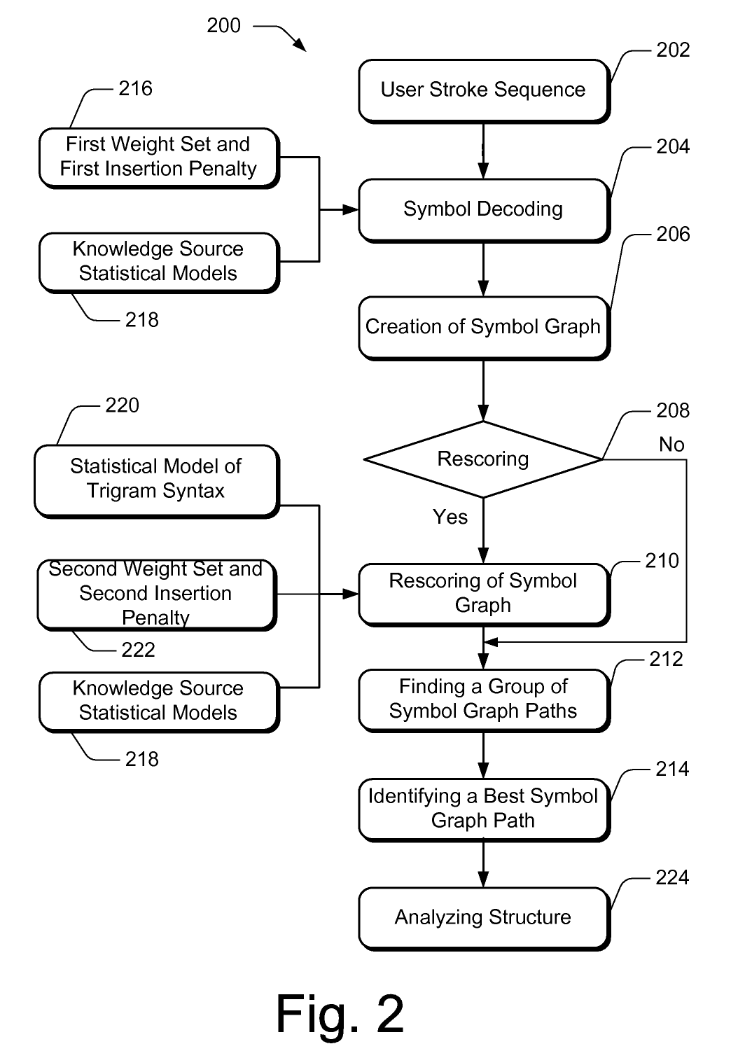

Once the user handwriting input 104 reaches the handwriting recognition engine 158, handwriting input 104 is first decoded by the decoding engine 160. Decoding engine 160 contains user handwriting input decoding module 162 (e.g. symbol decoding at operation 204, FIG. 2) and symbol graph creation module 164 (e.g. creation of symbol graph at operation 206, FIG. 2). In this embodiment, the symbol graph is generated via decoding. Also, in this embodiment, the symbol graph is used to store a first group of symbol paths which are symbol hypotheses that are stored in the symbol graph. The symbol graph in this embodiment, is used to store the alternative symbol sequences that result from decoding. The symbol graph does this by storing the alternative symbol sequences in the form of arcs in the symbol graph that correspond to symbols and symbol sequences that are encoded by the paths through the symbol graph nodes.

Once the decoding engine 160 decodes user handwriting input 104 and produces a symbol graph, rescoring engine 166 rescores the symbol graph created by the symbol graph creation module 164. First, rescoring engine 166 rescores the graph via a symbol graph rescoring module 168. Then, a symbol paths module 170 finds a group of symbol paths from the rescored symbol graph. These rescored paths comprise a second group of symbol paths which are a different group than the first group of paths created by decoding engine 160. This rescoring takes more data (e.g. different knowledge source statistical models) into consideration than was possible during the initial one-pass decoding by decoding engine 160.

From this second group of symbol paths, a best symbol path identification module 172 finds a best symbol path (further discussed at operation 214) and passes the best symbol path to structure analysis engine 174. Structure analysis engine 174 then analyzes the structure of the best symbol path. This produces the most likely handwriting input that the user 102 actually input into computing device 106. This is represented as recognized handwriting 108. Computing device 106 can optionally omit the use of rescoring engine 166 and recognized handwriting 108 can be found by using decoding engine 160 and structure analysis engine 174. In one embodiment, recognized handwriting 108 can then be displayed in a user interface as illustrated in FIG. 5 using other applications 154 or using its own application.

### Illustrative Processes

FIGS. 2-4 are embodiments of processes for recognizing input handwritten expressions. For instance, process 200 illustrates an embodiment of improved handwriting recognition by using symbol graph based discriminative training and rescoring. Process 200 as well as other processes described throughout, is illustrated as a logical flow graph, which represents a sequence of operations that can be implemented in hardware, software, or a combination thereof. In the context of software, the blocks represent computer executable instructions that when executed by one or more processors, perform the recited operations. Generally, computer executable instructions include routines, programs, objects, components, data structures, and the like that perform particular functions or implement particular functions or implement particular abstract data types. The order in which the operations are describes is not intended to be constructed as a limitation, and any number of the described operations can be combined in any order and/or in parallel to implement the process.

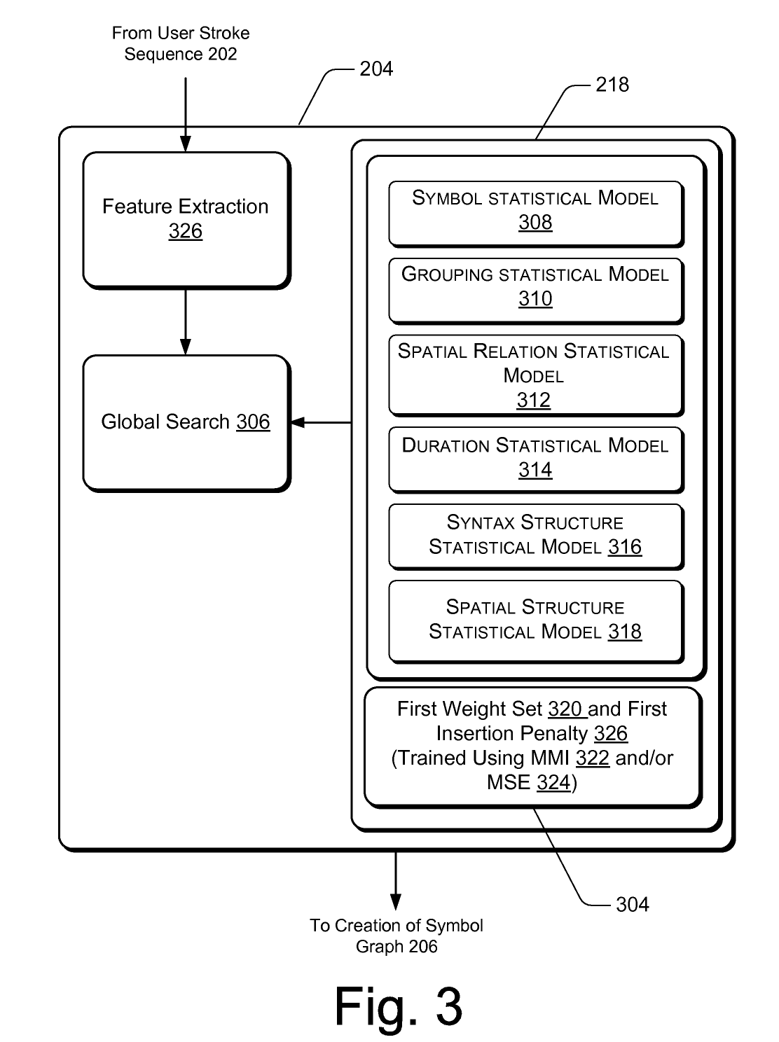

For discussion purposes, process 200 is described with reference to illustrative architecture 100 of FIG. 1. In process 200, a user first inputs a user stroke sequence at operation 202. Second, the user stroke sequence undergoes symbol decoding at operation 204. Symbol decoding at operation 204 may be accomplished with a one-pass dynamic programming based symbol decoding generation algorithm. This algorithm is used to embed segmentation into symbol identification to form a unified framework for symbol recognition. An illustrative example of symbol decoding at operation 204 will be discussed further in FIG. 3.

Creation of symbol graph at operation 206 occurs after the user's stroke sequence is input at operation 202 and after the symbol decoding of operation 204. In one embodiment, a decision to rescore the symbol graph at operation 208 and actually rescoring the symbol graph at operation 210 can be applied in a post-processing stage. Identifying a best symbol graph path at operation 214 is executed after rescoring and finding a group of symbol paths at operation 212.

Identifying a best symbol graph path at operation 214 can be done using an A* tree search or the stack algorithm. In this embodiment, it would be different from a typical A* search where the incomplete portion of a partial path is estimated using heuristics. Instead, in this embodiment, a tree search uses the partial path map prepared in the decoding and the score of the incomplete portion of the path in the search tree that is exactly known. Then the structure of the best symbol path is analyzed at operation 224 to produce the most likely candidate of what the user 102 actually input. Specifically, during the analysis of the structure at operation 224, the dominant symbols such as fraction lines, radical signs, integration signs, summation signs as well as other dominant symbols which also include scripts such as super scripts and sub scripts will have their control regions analyzed. The final expression can then be found.

Alternately in another embodiment, if rescoring at operation 208 is not chosen, a group of symbol graph paths can be found at operation 212 in which a best symbol graph path is identified at operation 214 (as discussed above) and the best symbol graph path has its structure analyzed at operation 224. This produces the most likely candidate of what the user 102 actually input, and is output as recognized handwriting 108 which can be displayed in a user interface as in FIG. 5. If the decision to rescore at operation 208 is yes, then the rescoring of symbol graph at operation 210, finding a group of symbol graph paths at operation 212 and identifying a best symbol graph path at operation 214 may provide greater recognition accuracy. However, if the decision to rescore at operation 208 is no, then time and computation resources may be saved by proceeding straight to identifying a best symbol graph at 214.

Returning to operation 204, the symbol decoding may use a first weight set and first insertion penalty 216, as well as knowledge source statistical models 218. The first weight set and first insertion penalty 216 are trained during a discriminative training process that will be discussed below as well as the knowledge source statistical models 218. Rescoring of symbol graph at operation 210 uses a second set of knowledge source statistical models (e.g. the first set of knowledge source statistical models 218 plus the statistical model of trigram syntax 220). Its probability and the second weight set and second insertion penalty 222 will be discussed below.

FIG. 3 provides an illustration of an embodiment of symbol decoding operation 204. As illustrated above, this operation occurs after user inputs user handwriting input 104 and before creation of the symbol graph based at least in part on the decoding.

As illustrated, features of the user stroke sequence may be extracted at operation 326. These features then undergo a global search at operation 306. The global search of operation 306 may be produced using one or more trained parameters 304 and knowledge source statistical models 218. This Global search may use six (or less or more) knowledge source statistical models 308, 310, 312, 314, 316 and 318, which may help search for possible hypotheses during symbol decoding 204. Each of these knowledge source statistical models has a probability which is calculated during the symbol decoding 204. Each probability is calculated using a given a corresponding observation, such as a feature extracted during the feature extraction operation 326. Features might include: one segment of strokes or two consecutive segments of strokes in the user stroke sequence, symbol candidates corresponding to the observations, spatial relation candidates corresponding to the observations, or some or all of these which are taken from the user's stroke sequence. The probabilities of each knowledge source statistical model determines the contribution of each knowledge source to the overall statistical model.

Furthermore, during global search 306, each knowledge source statistical model probability is weighted using discriminately trained parameters 304. More specifically, the discriminatively trained weights 320 and insertion penalty 326 are exponential weights for the knowledge source statistical model probabilities used in the symbol decoding. In a similar manner, a second weight set and second insertion penalty 222 are used as exponential weights for a different set of knowledge source statistical model probabilities. Specifically, the second weight set and second insertion penalty 222 are used to weight the probability of a second set of knowledge source statistical models (e.g. the first set of knowledge source statistical models 218 plus statistical model of trigram syntax 220) and is used in rescoring of symbol graph 210. Both sets of parameters used to weigh the different model probabilities in decoding and rescoring are used to equalize the impacts of the different statistical models and to balance the insertion and deletion errors. Specifically, these parameters are used in the calculation of path scores of the symbol graph paths in the symbol graph. Both sets of parameters used in decoding and rescoring are discriminately trained and have a fixed value that remains the same regardless of the knowledge source statistical model probabilities which change depending on user stroke sequence input by user 102. Previously, the exponential weights and insertion penalty may have been manually trained. However, an automatic way to tune these parameters, such through discriminative training, may save time and computational resources. Thus, discriminative training serves to automatically optimize the knowledge source exponential weights and insertion penalty used in both decoding and rescoring. The embodiments presented herein may employ parameters which have been discriminately trained via Maximum Mutual Information (MMI) and Minimum Symbol Error (MSE) criterion. Of course, other embodiments may discriminately train parameter(s) in other ways.

### Symbol Decoding Embodiment

There are several assumptions made in this embodiment of symbol decoding at operation 204. First, it is assumed that a user always writes a symbol without any insertion of irrelevant strokes before she finishes the symbol and each symbol can have at most of L strokes. The goal of this embodiment of symbol decoding is to find out a symbol sequence Ŝ that maximize a posterior probability P(S|O) given a user stroke sequence 202 O=o₁o₂ . . . o_{N}, over all possible symbol sequences S=s₁s₂ . . . s_{K}. Here K, which is unknown, is the number of symbols in a symbol sequence, and sₖ represents a symbol belonging to a limited symbol set Ω. Two hidden variables are introduced into the global search 306, which makes the Maximum A Posterior (MAP) objective function become

$$\hat{S} = {\text{arg} max}_{B , S , R} P ( B , S , R \vert O ) = {\text{arg} max}_{B , S , R} P ( O , B , S , R ) \qquad ( 1 )$$

Where B=(b₀=0)<b₁<b₂< . . . <(b_{K}=N) denotes a sequence of stroke indexes corresponding to symbol boundaries (the end stroke of a symbol), and R=r₁r₂ . . . r_{K} represents a sequence of spatial relations between every two consecutive symbols. The second equal mark is satisfied because of the Bayes theorem.

By taking into account the knowledge source statistical models 218: symbol 308, grouping 310, spatial relation 310, duration 314, syntax structure 316 and special structure 318 and their probabilities, the MAP objective could be expressed as

$$P ( O , B , S , R ) = P ( O \vert B , S , R ) P ( B \vert S , R ) P ( S \vert R ) P ( R ) = {\prod }_{k = 1}^{K} [ P ( {o}_{i}^{( k )} \vert {s}_{k} ) P ( {o}_{g}^{( k )} \vert {s}_{k} ) P ( {o}_{r}^{( k )} \vert {r}_{k} ) \times P ( {b}_{k} - {b}_{k - 1} \vert {s}_{k} ) P ( {s}_{k} \vert {s}_{k - 1} , {r}_{k} ) P ( {r}_{k} \vert {r}_{k - 1} ) ] = {\prod }_{k = 1}^{K} {\prod }_{i = 1}^{D} {p}_{k , i} \qquad ( 2 )$$

where D=6 represents the number of knowledge source statistical models in the search which is represented by equation (2) and the probabilities p_{k,i} for i being 1 to 6 are defined as

P_{k,1}=P(oᵢ^{(k)}|sₖ): symbol likelihood

P_{k,2}=P(o_{g}^{(k)}|sₖ): grouping likelihood

P_{k,3}=P(oᵣ^{(k)}|rₖ): spatial likelihood

P_{k,4}=P(bₖ−bₖ₋₁|sₖ): duration probability

P_{k,5}=P(sₖ|sₖ₋₁rₖ): syntax structure probability

P_{k,6}=P(rₖ|rₖ−1): spatial structure probability

A one-pass dynamic programming global search 306 of the optimal symbol sequence is then applied through the state space defined by the knowledge sources. Here, creation of symbol graph at operation 206 permits a first group of symbol paths at operation 212 to be found, and then single best symbol graph paths can then be identified at operation 214. To create the symbol graph at operation 206, we only need memorize all symbol sequence hypotheses recombined into each symbol hypotheses for each incoming stroke, rather than just the best surviving symbol sequence hypothesis. Thus, symbol decoding at operation 204 of the user's stroke sequence creates symbol graph at operation 206.

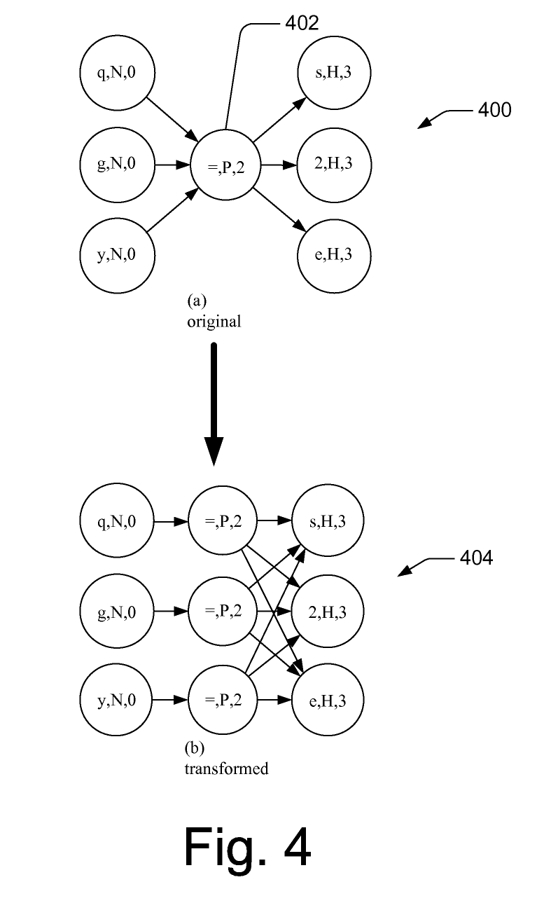

A group of one or more symbol graph paths can be found at operation 212. This embodiment of creation of symbol graph at operation 206, stores the alternative symbol sequences in the form of a symbol graph in which the arcs correspond to symbols and symbol sequences are encoded by the paths through the symbol graph nodes. Specifically, in this embodiment of the creation of symbol graph at operation 206, a path score is determined for a plurality of symbol-relation pairs that represent a symbol and its spatial relation pairs that each represent a symbol and its spatial relation to a predecessor symbol. Then a best symbol graph path can be identified at operation 214. The best symbol graph path represents the most likely symbol sequence the user actually input. For example in one embodiment, each node has a label with three values consisting of a symbol, a spatial relation and an ending stroke for the symbol. For example, a node 402 (FIG. 4) has a symbol “=” the spatial relation “P”, which stands for superscript, and the ending stroke value “2”, where the strokes are numbered from 0 to N.

A symbol graph having nodes and links is constructed by backtracking through the strokes from the last stroke to the first stroke and assigning scores to the links based on the path scores for the symbol-relation pairs. The symbol graph's nodes (as illustrated in FIG. 4) are connected to each other by links or path segments where each path segment between two nodes represents a symbol-relation pair at a particular ending stroke. Each path segment has an associated score such that following a score can be generated for any path from a starting node to an ending node by summing the scores along the individual path segments on the path. The identity of a best symbol graph path is calculated through the A* tree search at operation 214.

In this embodiment, the path scores of the symbol graph paths are a product of the weighted probabilities from all knowledge sources and the insertion penalty stored in all edges belonging to that path. Here, discriminately trained parameters are used in the decoding to equalize the impacts of the different knowledge source statistical models and balance the insertion and deletion errors. Previously these parameters were determined by manually training them on a development set to minimize recognition errors. However, this may only feasible for low-dimensional search space such as in speech recognition where there are few parameters and manually training is relatively easy and thusly, may not suited for use in online handwriting recognition in some instances.

In the decoding algorithm, discriminately trained weights 320 are assigned to the probabilities calculated from the different knowledge source statistical models 308, 310, 312, 314, 316 and 318 and a discriminately trained insertion penalty 326 is also used in decoding to improve recognition. The MAP objective in equation (2) becomes:

P_{w}(O,B,S,R)=Πₖ₌₁^{K}(Πₖ₌₁^{D}p_{k,}^{K}×I)=Πₖ₌₁^{K}pₖ (3)

where pₖ is defined as a combined score of all knowledge sources and the insertion penalty for the k'th symbol in a symbol sequence

pₖ=Πᵢ₌₁^{D}p_{k,k}^{P}×I (4)

wi represents the exponential weights of the i'th statistical probability p_{k,i} and I stands for the insertion penalty. The parameter vector needs to be trained is expressed as w=[w₁,w₂, . . . ,w_{D},I]^{T}. Equations 3 and 4 are one embodiment of a global search that can be performed at operation 306.

### Symbol Graph Based Discriminative Training Rationale

Discriminative training of the exponential weights 320 and insertion penalty 326 improves online handwriting recognition by formulating an objective function that penalizes the knowledge source statistical model probabilities that are liable to increase error. This is done by weighing those probabilities with weights and an insertion penalty. Discriminative training requires a set of competing symbol sequences for one written expression. In order to speed up computation, the generic symbol sequences can be represented by only those that have a reasonably high probability. A set of possible symbol sequences could be represented by an N-best list, that is, a list of the N most likely symbol sequences. A much more efficient way to represent them, however, is with by creating symbol graph at operation 206. This symbol graph stores the alternative symbol sequences in the form of a symbol graph in which the arcs correspond to symbols and symbol sequences are encoded by the paths through the graph.

One advantage of using symbol graphs is that the same symbol graph can be used for each iteration of discriminative training. This addresses the most time-consuming aspect of discriminative training, which is to find the most likely symbol sequences only once. This approach assumes that the initially generated graph covers all the symbol sequences that will have a high probability even given the parameters generated during later iterations of training. If this is not true, it will be helpful to regenerate graphs more than once during the training. Thus, both the symbol decoding at operation 204 and the discriminative training processes are based on symbol graphs. The symbol graph can also be further used in rescoring at operation 210.

In this embodiment, discriminative training is carried out based on the symbol graph 206 generated via symbol decoding 204. Further, in this embodiment, there is no graph regeneration during the entire training procedure which means the symbol graph 206 is used repeatedly.

### Symbol Graph Discriminative Training Criterion Overview

In this particular embodiment of discriminative training, the training will train exponential weights and at least one insertion penalty, but it will not train the knowledge source statistical model probabilities themselves.

Specifically, the knowledge source statistical model probabilities are calculated during decoding of training data and stored in the symbol graph. Here, an initial set of weights and initial insertion penalty are used. The weights are initially set at 1.0 and the insertion penalty is initially set at 0.0. The initial set of weights and initial insertion penalty are then trained using a discriminative training algorithm on the symbol graph and with MSE or MMI criterion, wherein the probabilities of the knowledge sources are already stored in the symbol graph which omit the need for recalculation.

During the training, the MSE and MMI criterion consider the training data and the “known” correct symbol sequence (e.g. the training data) and possible symbol sequences and creates an objective function. The derivative of the objective function is then taken to get the gradient. The initial set of weights an initial insertion penalty are then updated based on the gradients via the quasi-Newton method.

### The Discriminative Training Algorithm

In this embodiment, it is assumed that there are M training expressions. For training file m,1≦m≦M, the stroke sequence is Oₘ, the reference symbol sequence is Sₘ, and the reference symbol boundaries is Bₘ. No reference spatial relations are used in this embodiment as we focus on segmentation and symbol recognition quality. Hereafter, a symbol being correct means both its boundaries and symbol identity being correct, while a symbol sequence being correct indicates all symbol boundaries and identities in the sequence being correct. It is also assumed in this embodiment, that S, B and R to be any possible symbol sequence, symbol boundary sequence and spatial relation sequence, respectively. Probability calculations in the training are carried out with probabilities scaled by a factor of K. This is important if discriminative training is to lead to good test-set performance.

Different embodiments can also use different criterion or multiple criterion. Two embodiments discussed here use criterion from Maximum Mutual Information (MMI) and Minimum Symbol Error (MSE) criterion. In objective optimization, the quasi-Newton method is used to find local optimal of the functions. Therefore, the derivative of the objective with respect to each knowledge source statistical model exponential weight 320 and insertion penalty 326 must be produced. All these objectives and derivatives can be efficiently calculated via a Forward-Backward algorithm based on a symbol graph.

### The MMI Criterion

In one embodiment, MMI training is used as the discriminative training criterion because it maximizes the mutual information between the training symbol sequence and the observation sequence. Its objective function can be expressed as a difference of joint probabilities:

$${}_{MMI} ( w ) = {\sum }_{m = 1}^{M} log \frac{{\sum }_{R} {{P}_{w} ( {O}_{m} , {B}_{m} , {S}_{m} , R )}^{K}}{{\sum }_{B , S , R} {{P}_{w} ( {O}_{m} , B , S , R )}^{K}} \qquad ( 5 )$$

Probability P_{w}(O,B,S,R) is defined as in (3). The MMI criterion equals the posterior probability of the correct symbol sequence, that is

$${ℱ}_{MMI} ( w ) = {\sum }_{m = 1}^{M} log {{P}_{w} ( {B}_{m} , {S}_{m} \vert {O}_{m} )}^{k}$$

Substituting Equation (3) into (5), we have

$${ℱ}_{MMI} ( w ) = {\sum }_{m = 1}^{M} log \frac{{\sum }_{R} {\prod }_{k = 1}^{K} {p}_{m , k}^{k}}{{\sum }_{B , S , R} {\prod }_{k = 1}^{K} {p}_{k}^{k}} \qquad ( 6 )$$

where p_{m,k} is the same with pₖ except that the former corresponds to the reference symbol sequence of the m'th training data.

In the condition that all hypothesized symbol sequences are encoded by a symbol graph, the symbol graph based MMI criterion can be formulated as

$${ℱ}_{MMI} ( w ) = {\sum }_{m = 1}^{M} log \frac{{\sum }_{{υ}_{m}} {\prod }_{e ∈ {υ}_{m}} {p}_{e}^{k}}{{\sum }_{υ} {\prod }_{e ∈ υ} {p}_{e}^{k}} \qquad ( 7 )$$

where Uₘ denotes a correct path in the symbol graph for the m'th file, U represents any path in the symbol graph, e ε U stands for an edge belonging to path U, and Pₑ is the combined score with respect to edge e. By comparing equations (6) and (7), one can found that Pₑ and Pₖ are the same thing of different notations.

The denominator of Equation (7) is a sum of the path scores over all hypotheses. Given a symbol graph, it can be efficiently calculated by the Forward-Backward algorithm as α₀β₀. While the numerator is a sum of the path scores over all correct symbol sequences. It can be calculated within the sub-graph G′ constructed just by correct paths in the original graph G. Assume that the forward and backward probabilities for the sub-graph are α′ and β′, then the numerator can be calculated as α′₀β′₀. Finally, the objective becomes

$${ℱ}_{MMI} ( w ) = {\sum }_{m = 1}^{M} log \frac{{α}_{0}^{′} {β}_{0}^{′}}{{α}_{0} {β}_{0}}$$

The derivatives of the MMI objective function with respect to the exponential weights and the insertion penalty can then be calculated as:

$$\begin{matrix}\frac{\partial {ℱ}_{MMI} ( w )}{\partial {w}_{j}} = {\sum }_{m = 1}^{M} [ \frac{{\sum }_{{U}_{m}} {\prod }_{e ∈ {U}_{m}} {p}_{e}^{k} {\sum }_{e ∈ {U}_{m}} log {p}_{e , j}^{k}}{{\sum }_{{U}_{m}} {\prod }_{e ∈ {U}_{m}} {p}_{e}^{k}} - \frac{{\sum }_{U} {\prod }_{e ∈ U} {p}_{e}^{k} {\sum }_{e ∈ U} log {p}_{e , j}^{k}}{{\sum }_{U} {\prod }_{e ∈ U} {p}_{e}^{k}} ] \\ = {\sum }_{m = 1}^{M} ( \frac{{\sum }_{{U}_{m}} {\prod }_{e ∈ {U}_{m}} {p}_{e , j}^{k} {α}_{e}^{′} {p}_{e}^{k} {β}_{e}^{′}}{{α}_{0}^{′} {β}_{0}^{′}} - \frac{{\sum }_{e ∈ G} log {p}_{e , j}^{k} {α}_{e} {p}_{e}^{k} {β}_{e}}{{α}_{0} {β}_{0}} )\end{matrix}$$

$$\begin{matrix}\frac{\partial {ℱ}_{MMI} ( w )}{\partial I} = {\sum }_{m = 1}^{M} [ \frac{{\sum }_{{U}_{m}} {\prod }_{e ∈ {U}_{m}} {p}_{e}^{k} {\sum }_{e ∈ {U}_{m}} κ {I}^{- 1}}{\sum {U}_{m} {\prod }_{e ∈ {U}_{m}} {p}_{e}^{k}} - \frac{{\sum }_{U} {\prod }_{e ∈ {U}_{m}} {p}_{e}^{k} {\sum }_{e ∈ U} κ {I}^{- 1}}{{\sum }_{U} {\prod }_{e ∈ U} {p}_{e}^{k}} ] \\ = κ {I}^{- 1} {\sum }_{m = 1}^{M} ( \frac{{\sum }_{e ∈ {G}^{′}} {α}_{e}^{′} {p}_{e}^{k} {β}_{e}^{′}}{{α}_{0}^{′} {β}_{0}^{′}} - \frac{{\sum }_{e ∈ G} {α}_{e} {p}_{e}^{k} {β}_{e}}{{α}_{0} {β}_{0}} )\end{matrix}$$

In the derivatives, αₑ and βₑ indicate the forward and backward probabilities of edge e.

### The MSE Criterion

In another embodiment, the Minimum Symbol Error criterion is used in discriminative training. The Minimum Symbol Error (MSE) criterion is directly related to Symbol Error Rate (SER) which is the scoring criterion generally used in symbol recognition. It is a smoothed approximation to the symbol accuracy measured on the output of the symbol recognition stage given the training data. The objective function in the MSE embodiment, which is to be maximized, is:

$${ℱ}_{MSE} ( w ) = {\sum }_{m = 1}^{M} {\sum }_{B , S} {{P}_{w} ( B , S \vert {O}_{m} )}^{k} A ( BS , {B}_{m} , {S}_{m} ) \qquad ( 8 )$$

where P_{w}(B,S|Oₘ)^{K} is defined as the scaled posterior probability of a symbol sequence being the correct one given the weighting parameters. It can be expressed as

$${{P}_{w} ( B , S \vert {O}_{m} )}^{k} = \frac{{\sum }_{R} {{P}_{w} ( {O}_{m} , B , S , R )}^{k}}{{\sum }_{B , S , R} {{P}_{w} ( {O}_{m} , B , S , R )}^{k}} \qquad ( 9 )$$

A(BS,BₘSₘ) in Equation (8) represents the row accuracy of a symbol sequence given the reference for the m'th file, which equals the number of correct symbols

$$A ( BS , {B}_{m} , {S}_{m} ) = {\sum }_{k = 1}^{K} {a}_{k} , {a}_{k} = \{ \begin{matrix}1 & {s}_{k} , {b}_{k - 1} , {b}_{k} are correct \\ 0 & otherwise\end{matrix}$$

The criterion is an average over all possible symbol sequences (weighted by their posterior probabilities) of the raw symbol accuracy for an expression. By expanding P_{w}(B,S|Oₘ)^{K}, Equation (8) can be expressed as

$${ℱ}_{MSE} ( w ) = {\sum }_{m = 1}^{M} \frac{{\sum }_{B , S , R} {\prod }_{k = 1}^{K} {p}_{k}^{k} A ( BS , {B}_{m} , {S}_{m} )}{{\sum }_{B , S , R} {\prod }_{k = 1}^{K} {p}_{k}^{k}}$$

Similar to the graph based MMI training embodiment, the graph based MSE embodiment criterion has the form

$${ℱ}_{MSE} ( w ) = {\sum }_{m = 1}^{M} \frac{{\sum }_{U} {\prod }_{e ∈ U} {p}_{e}^{k} {\sum }_{e ∈ U , e ∈ C} 1}{{\sum }_{U} {\prod }_{e ∈ U} {p}_{e}^{k}} \qquad ( 10 )$$

where C denotes the set of correct edges. By changing the order of sums in the numerator, Equation (10) becomes

$${ℱ}_{MSE} ( w ) = {\sum }_{m = 1}^{M} \frac{{\sum }_{e ∈ C} {\sum }_{U , e ∈ U} {\prod }_{{e}^{′} ∈ U} {p}_{{e}^{′}}^{k}}{{\sum }_{U} {\prod }_{e ∈ U} {p}_{e}^{k}} \qquad ( 11 )$$

The second sum in the numerator indicates the sum of the path scores over all hypotheses that pass e. It can be calculated from the Forward-Backward as αₑpₑ^{K}βₑ. The final MSE objective in the embodiment, can then be formulated by the forward and backward probabilities as

$${ℱ}_{MSE} ( w ) = {\sum }_{m = 1}^{M} \frac{{\sum }_{e ∈ C} {α}_{e} {p}_{e}^{k} {β}_{e}}{{α}_{0} {β}_{0}} \qquad ( 12 )$$

Thus Equation (12), equals the sum of posterior probabilities over all correct edges.

For the quasi-Newton optimization, the derivatives of the MSE objective function with respect to the exponential weights and the insertion penalty can be calculated as

$$\begin{matrix}\frac{\partial {F}_{MSE} ( w )}{\partial {w}_{j}} = {\sum }_{m = 1}^{M} [ \frac{{\sum }_{U} {\prod }_{e ∈ U} {p}_{e}^{k} {\sum }_{e ∈ U , e ∈ C} 1}{{\sum }_{U} {\prod }_{e ∈ U} {p}_{e}^{k}} - \frac{\begin{matrix}( {\sum }_{U} {\prod }_{e ∈ U} {p}_{e}^{k} {\sum }_{e ∈ U , e ∈ C} 1 ) \\ ( {\sum }_{U} {\prod }_{e ∈ U} {p}_{e}^{k} {\sum }_{e ∈ U} log {p}_{e , j}^{k} )\end{matrix}}{{( {\sum }_{U} {\prod }_{e ∈ U} {p}_{e}^{k} )}^{2}} ] \\ = {\sum }_{m = 1}^{M} [ \frac{{\sum }_{e ∈ C} {\sum }_{{e}^{′}} log {p}_{{e}^{′} , j}^{k} {α}_{{e}^{′}}^{( e )} {p}_{{e}^{′}}^{k} {β}_{{e}^{′}}^{( e )}}{{α}_{0} {β}_{0}} - \frac{{\sum }_{e ∈ C} {α}_{e} {p}_{e}^{k} {β}_{e}}{{α}_{0} {β}_{0}} \frac{{\sum }_{e} log {p}_{e , j}^{k} {α}_{e} {p}_{e}^{k} {β}_{e}}{{α}_{0} {β}_{0}} ]\end{matrix}$$

$$\begin{matrix}\frac{\partial {F}_{MSE} ( w )}{\partial I} = {\sum }_{m = 1}^{M} [ \frac{{\sum }_{U} {\prod }_{e ∈ U} {p}_{e}^{k} {\sum }_{e ∈ U} κ {l}^{- 1} {\sum }_{e ∈ U , e ∈ C} 1}{{\sum }_{U} {\prod }_{e ∈ U} {p}_{e}^{k}} - \frac{\begin{matrix}( {\sum }_{U} {\prod }_{e ∈ U} {p}_{e}^{k} {\sum }_{e ∈ U , e ∈ C} 1 ) \\ ( {\sum }_{U} {\prod }_{e ∈ U} {p}_{e}^{k} {\sum }_{e ∈ U} κ {I}^{- 1} )\end{matrix}}{{( {\sum }_{U} {\prod }_{e ∈ U} {p}_{e}^{k} )}^{2}} ] \\ = κ {I}^{- 1} {\sum }_{m = 1}^{M} [ \frac{{\sum }_{e ∈ C} {\sum }_{{e}^{′}} {α}_{{e}^{′}}^{( e )} {p}_{{e}^{′}}^{k} {β}_{{e}^{′}}^{( e )}}{{α}_{0} {β}_{0}} - \frac{{\sum }_{e ∈ C} {α}_{e} {p}_{e}^{k} {β}_{e}}{{α}_{0} {β}_{0}} \frac{{\sum }_{e} {α}_{e} {p}_{e}^{k} {β}_{e}}{{α}_{0} {β}_{0}} ]\end{matrix}$$

Here α^{(e)} and β^{(e)} indicate the forward and backward probabilities calculated within the sub-graph constructed by paths passing through edge e, while α_{e′}^{(e)} and β_{e′}^{(e)} represents the particular probabilities of edge e′.

### Experimental Results

Symbol graphs are generated first by using the symbol decoding engine on the training data. Since MMI training must calculate the posterior probability of the correct paths, only those graphs with zero graph symbol error rate (GER) are randomly selected. The final data set for discriminative training has about 2,500 formulas, a comparable size with the test set. The graphs are then used for multiple iterations of MMI and MSE training. All the knowledge source statistical model exponential weights and the insertion penalty are initialized to 1.0 and 0.0 before discriminative training.

In the embodiments described herein, the experimental results of the discriminative training are presented in this section. Of course, it is to be appreciated that these results are merely illustrative and non-limiting.

### Convergence Experimental Results

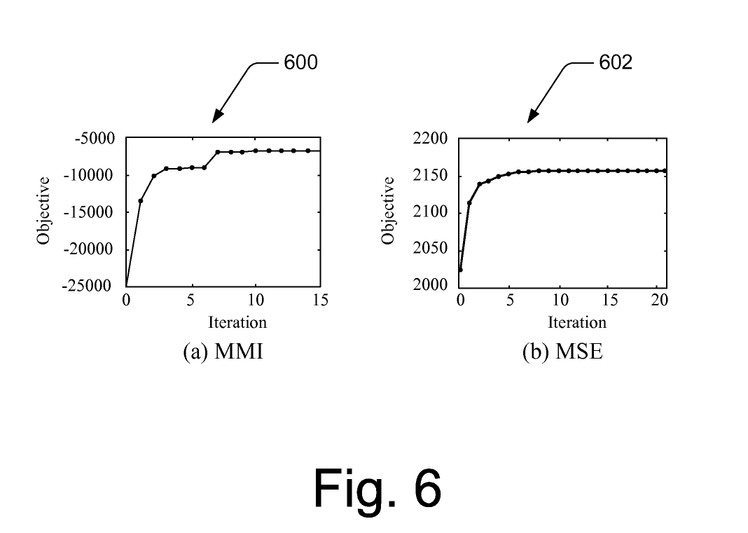

FIG. 6 shows the convergence of discriminative training with smoothing factor1/κ=0.3 in the MMI graph 600 and the MSE graph 602. Both MMI and MSE objectives are monotonically increased during the process.

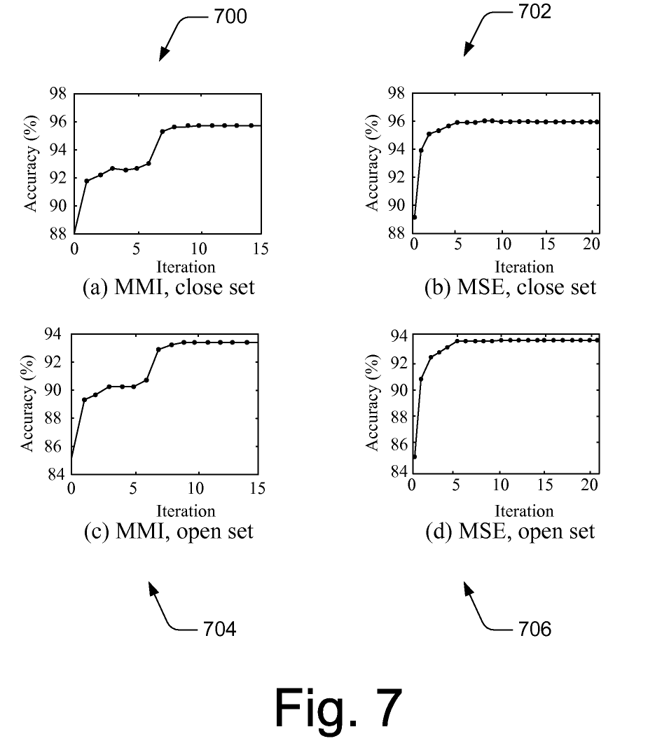

At each iteration of the training, the best path in the symbol graph was investigated given the latest parameters. Both training and testing data are investigated. FIG. 7 shows the corresponding results with respect to symbol accuracy. In FIG. 7, the graph of MMI close set 700 and the graph of MSE close set 702 were obtained on training data, while the graph of MMI open set 704 and the graph of MSE open set 706 were obtained on testing data. Thus, from FIG. 7, it is demonstrated that the improved performance can generalize to unseen data very well.

### Symbol Accuracy Experimental Results

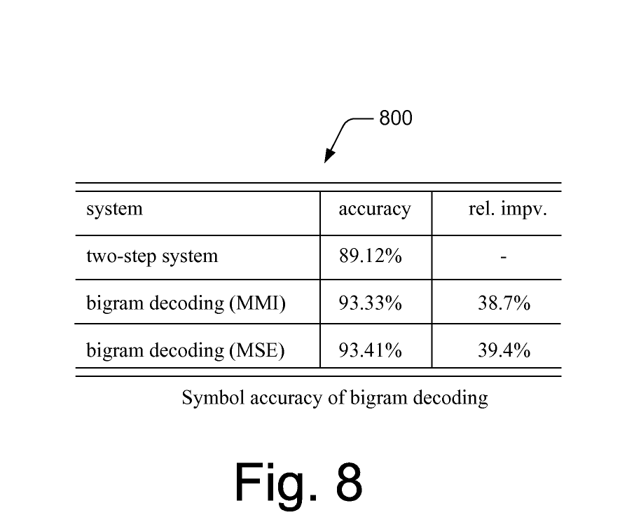

After discriminative training, the obtained knowledge source statistical model exponential weights 320 and insertion penalty 326, in the symbol decoding step were used to do a global search at operation 306. The table 800 in FIG. 8, shows the symbol accuracy and relative improvement obtained with different system configurations.

The first line in table 800, illustrates the baseline results produced by traditional systems in which segmentation and symbol recognition are two separated steps in contrast to these embodiments which are one step. When comparing results of MMI and MSE discriminative training, it may be noticed that MSE training has achieved better performance than MMI training. The reason is that while the MMI criterion maximizes the posterior probability of the correct paths, the MSE criterion may distinguish all correct edges even in the incorrect paths. The MSE criterion may have a closer relationship with the performance metric of symbol recognition, therefore, optimization of the MSE objective function may improve symbol accuracy more than MMI in some instances.

### Symbol Graph Rescoring

As illustrated in FIG. 2, after discriminative training of the exponential weights and the insertion penalty, the system may be further improved, in some instances, by symbol graph rescoring at operation 210. Rescoring provides an opportunity to further improve symbol accuracy by using more complex information that is difficult to be used in the one-pass decoding.

In one embodiment, a trigram syntax model is used rescore the symbol graph so as to make the correct path through the symbol graph nodes more competitive. The trigram syntax model 220 is formed by computing a probability for each symbol-relation pair given the preceding two symbol-relation pairs on a training set

$$P ( {s}_{k} {r}_{k} \vert {s}_{k - 2} {r}_{k - 2} , {s}_{k - 1} {r}_{k - 1} ) = \frac{c ( {s}_{k - 2} {r}_{k - 2} , {s}_{k - 1} {r}_{k - 1} , {s}_{k} {r}_{k} )}{c ( {s}_{k - 2} {r}_{k - 2} , {s}_{k - 1} {r}_{k - 1} )}$$

Where c(sₖ₋₂rₖ₋₂,sₖ₋₁rₖ,sₖrₖ) represents the number of times that triple (sₖ₋₂rₖ₋₂,sₖ₋₁rₖ₋₁,sₖrₖ) occurs in the training data and c(sₖ₋₂rₖ₋₂,sₖ₋₁rₖ₋₁) is the number of times that (sₖ₋₂rₖ₋₂,sₖ₋₁rₖ₋₁) is found in the training data. For triples that do not appear in the training data, smoothing techniques can be used to approximate the probability.

### Expanding the Symbol Graph for Rescoring

From the definition of the trigram syntax model 220 in this embodiment, it is required to distinguish both the last and second last predecessors for a given symbol-relation pair. Since the symbol-level recombination in the bigram decoding distinguishes partial symbol sequence hypotheses s₁^{k}r₁^{k} only by their final symbol-relation pair sₖrₖ, a symbol graph constructed in this way would have ambiguities of the second left context for each arc. Therefore, the original symbol graph must be transformed to a proper format before rescoring. FIG. 4 shows an example of the transformation. Symbol graph 400 is the symbol graph before transformation and symbol graph 404 is the symbol graph after transformation. In comparison with the original symbol graph 400, the transformed symbol graph 402 duplicated the central node so as to distinguish different paths recombined into the nodes at the right side.

In this embodiment, after graph expansion, the trigram probability could be used to recalculate the score for each arc as follows

pₖ=Πᵢ₌₁^{D}p_{k,1} ^{wk}×I (13)

Here D=7 rather than 6 in bigram decoding (Equation (4), and P_{k,7}=P(sₖrₖ|sₖ₋₂rₖ₋₂,sₖ₋₁rₖ₋₁) indicates the trigram probability. The exponential weights of the trigram probability together with the first weight set and insertion penalty 216 form the second weight set and the second insertion penalty 222. These can be discriminatively trained based on the transformed symbol graph, in the same way as described above. The second weight set and second insertion penalty 222 will be used to weight a second set of knowledge source statistical models (e.g. the knowledge source statistical models 218 plus the statistical model of the trigram syntax 220) in a similar way that first weight set and first insertion penalty 216 weights the knowledge source statistical models 218. Hence in this embodiment, there are two sets of discriminately trained knowledge source statistical model exponential weights and insertion penalties in the system, one is of six dimensions (first weight set and first insertion penalty 216) for bigram decoding and the other one is of seven dimensions (second weight set and second insertion penalty 222) and for trigram rescoring.

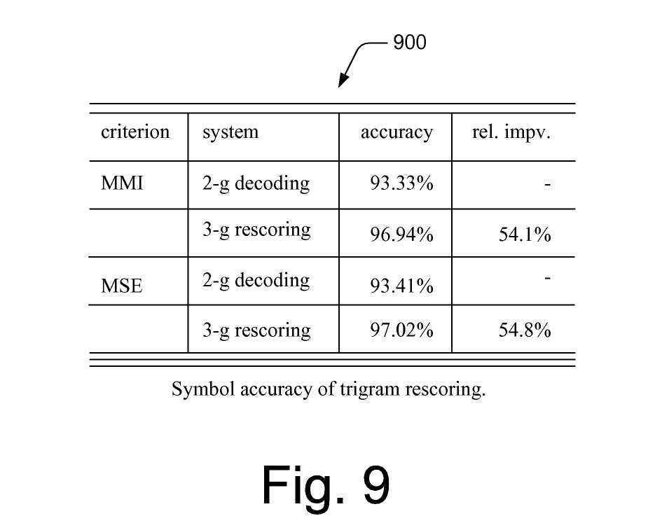

Thus in this embodiment, recognition performance is achieved by symbol graph discriminative training and rescoring. A first weight set and first insertion penalty 216 were trained using MMI and MSE criterion. After symbol graph rescoring at operation 210, the symbol path with the highest score was extracted and compared with the reference to calculate the symbol accuracy. Table 900 in FIG. 9 shows this embodiment's average symbol accuracy. Compared to the one-pass bigram decoding, the trigram rescoring significantly improved the symbol accuracy of this embodiment. The best result even exceeded 97%.

### Conclusion

Thus, the embodiments presented herein, may make use of discriminative criterion such as Maximum Mutual Information (MMI) and the Minimum Symbol Error (MSE) criterion for training knowledge source statistical model exponential weights and insertion penalties for use in symbol decoding for handwritten expression recognition. Both embodiments of MMI and MSE training may be carried out based on symbol graphs to store alternative hypotheses of the training data. This embodiment also used the quasi-Newton method for the optimization of the objective functions. Additionally the Forward-Backward algorithm was used to find their derivatives through the symbol graph. Experiments for this embodiment showed that both criterion produced significant improvement on symbol accuracy. Moreover, MSE gave better results than MMI in some embodiments.

After discriminative training, symbol graph rescoring was then performed by a trigram syntax model. The symbol graph was first modified by expanding the nodes in the symbol graph to prevent ambiguous paths for the trigram probability computation. Then arc scores from the symbol graph are recomputed with the new probabilities. To do this, a new set of a second weight set and second insertion penalty were trained based on the expanded graph are used. Experimental results showed dramatic improvement of symbol recognition through trigram rescoring, producing a 97% in symbol accuracy in the described example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method implemented at least in part by a machine, comprising:
receiving a user stroke sequence corresponding to a handwritten expression;
decoding the user stroke sequence into a symbol graph, wherein the symbol graph is comprised of symbol hypotheses in the form of symbol paths through symbol hypotheses nodes that are based upon a first set of knowledge source statistical model probabilities, wherein the first set of knowledge source statistical model probabilities are weighted by a first set of discriminately trained exponential weights and a first discriminately trained insertion penalty;
if it is decided that the symbol graph is not to be rescored, then:
searching the symbol graph for a first group of symbol graph paths;
identifying a first best symbol graph path from the first group of symbol graph paths; and
analyzing the structure of the first best symbol graph path; and
if it is decided that the symbol graph is to be rescored, then:
rescoring the symbol graph with a second set of knowledge source statistical model probabilities that are weighted by a second set of discriminately trained exponential weights and a second discriminately trained insertion penalty;
searching the symbol graph for a second group of symbol graph paths;
identifying a second best symbol graph path from the second group of symbol graph paths; and
analyzing the structure of the second best symbol graph path.

2. The method of claim 1, further comprising wherein the rescoring of the symbol graph comprises rescoring the symbol graph using a trigram syntax model.

3. The method of claim 1, wherein the discriminative training comprises using a Maximum Mutual Information criterion, and wherein during discriminative training the discriminatively trained weights are used in calculating path scores of the symbol paths.

4. The method of claim 1, wherein the discriminative training comprises using a Minimum Symbol Error criterion, and wherein during discriminative training the discriminatively trained weights are used in calculating path scores of the symbol paths.

5. The method of claim 4 wherein the discriminative training uses a Quasi-Newton Method to final local optima.

6. The method of claim 1, wherein the handwritten expression is a mathematical expression.

7. A method implemented at least in part by a machine comprising:
receiving a user stroke sequence corresponding to a handwritten expression; and
decoding the user stroke sequence into a symbol graph, wherein the symbol graph is comprised of symbol hypotheses in the form of symbol paths through symbol hypotheses nodes which are based upon a set of knowledge source statistical model probabilities, wherein the knowledge source statistical model probabilities are weighted by a discriminately trained set of exponential weights and a discriminately trained insertion penalty.

8. The method of claim 7, wherein the set of knowledge source statistical model probabilities are a first set of knowledge source statistical model probabilities, the set of discriminately trained weights are a first set of discriminatively trained weights and the discriminately trained insertion penalty is a first discriminately trained penalty, and further comprising:
rescoring the symbol graph with a second set of knowledge source statistical model probabilities that are weighted by a second set of discriminately trained exponential weights and a second discriminately trained insertion penalty;
searching the symbol graph for a first group of symbol graph paths; and
identifying a first best symbol graph path from the first group of symbol graph paths.

9. The method of claim 8, further comprising rescoring using a trigram syntax model.

10. The method of claim 7, further comprising:
searching the symbol graph for a group of symbol graph paths; and
identifying a best symbol graph path from the group of symbol graph paths.

11. The method of claim 7, wherein the discriminative training comprises using a Maximum Mutual Information criterion, wherein during discriminative training the discriminatively trained weights are used in calculating path scores of the symbol paths.

12. The method of claim 7, wherein the discriminative training comprises using a Minimum Symbol Error criterion, wherein during discriminative training the discriminatively trained weights are used in calculating path scores of the symbol paths.

13. The method of claim 12 wherein the discriminative training uses a Quasi-Newton Method to final local optima.

14. A computer-readable medium having computer-executable instructions that, when executed on one or more processors, perform acts comprising:
receiving a user stroke sequence corresponding to a handwritten expression; and
decoding the user stroke sequence into a symbol graph, wherein the symbol graph is comprised of symbol hypotheses in the form of symbol paths through symbol hypotheses nodes that are based upon a set of knowledge source statistical model probabilities, wherein the knowledge source statistical model probabilities are weighted by a discriminately trained set of exponential weights and a discriminately trained insertion penalty.

15. The computer-readable medium of claim 14, wherein the set of knowledge statistical model probabilities is a first set of knowledge source statistical model probabilities, the set of discriminately trained weights is a first set of discriminatively trained weights and the discriminately trained insertion penalty is a first discriminately trained penalty, and further comprising:
rescoring the symbol graph with a second set of knowledge source statistical model probabilities that are weighted by a second set of discriminately trained exponential weights and a second discriminately trained insertion penalty;
searching the symbol graph for a first group of symbol graph paths; and
identifying a first best symbol graph path from the first group of symbol graph paths.

16. The computer-readable medium of claim 15, wherein the rescoring of the symbol graph comprises rescoring the symbol graph using a trigram syntax model.

17. The computer-readable medium of claim 14, further comprising:
searching the symbol graph for a group of symbol graph paths; and
identifying a best symbol graph path from the group of symbol graph paths.

18. The computer-readable medium of claim 14, wherein the discriminative training comprises using a Maximum Mutual Information criterion, wherein during discriminative training the discriminatively trained weights are used in calculating path scores of the symbol paths.

19. The computer-readable medium of claim 14, wherein the discriminative training comprises using a Minimum Symbol Error criterion, wherein during discriminative training the discriminatively trained weights are used in calculating path scores of the symbol paths.

20. The computer-readable medium of claim 18, wherein the discriminative training uses a Quasi-Newton Method to final local optima.
